(19) United States
(12) Patent Application Publication
(10) Pub. No.: US 2023/0370266 A1
(43) Pub. Date: Nov. 16, 2023

(54) TOKEN MANAGEMENT METHOD, END-USER MANAGEMENT APPARATUS, AND TOKEN PROCESSING APPARATUS

(71) Applicant: Hitachi, Ltd., Tokyo (JP)

(72) Inventors: Yuki KONDO, Tokyo (JP); Yasunori HASHIMOTO, Tokyo (JP); Tomokazu SAKAI, Tokyo (JP); Taichi ISHIGURE, Tokyo (JP)

(21) Appl. No.: 18/025,919

(22) PCT Filed: Sep. 7, 2021
(86) PCT No.: PCT/JP2021/032910

§ 371 Date: Mar. 13, 2023

(30) Foreign Application Priority Data
Sep. 25, 2020 (JP) 2020-161506

(51) Int. Cl. H04L 9/32; H04L 9/00

(52) U.S. Cl. CPC H04L 9/3213; H04L 9/3239; H04L 9/50

(57) ABSTRACT

A token management system records consent of an end user who entrusts operation of a token to a blockchain network participant organization deploying a token based on a request from an end user. The system includes a token registration unit, a user management unit, a token management unit, a policy management unit, and a life cycle management unit. The token registration unit registers a test result, an electronic signature, and a hash of a token program in the memory device as repository information, the electronic signature and the hash being confirmation evidence. The user management unit records consent of the end user, as a trail, to entrust operation of the token to a virtual organization, and registers the consent in the memory device. The token management unit records consent of the end user, as a trail, to deploy the token, and registers the consent in the memory device.

### TECHNICAL FIELD

The present invention relates to an electronic transaction system.

### BACKGROUND ART

In recent years, highly transparent and efficient financial transactions utilizing blockchain technology, represented by crypto-assets and security tokens, have been expanding. Expectations for a “token economy” are increasing in the fields of not only the financial transactions but also real estate management, asset management, power transactions, and the like. The token economy is an economic sphere in which ownership of things (physical assets) and usage rights of things (intangible assets, services) are converted into tokens as digital information to be issued and distributed.

The token economy is operated by a consortium composed of a plurality of stakeholders, including a “consortium owner” who designs the composition and governance of the consortium and “consortium participant companies” who participate in a blockchain network. The blockchain network is operated by the consortium owner and a plurality of consortium participant companies owning or substantially controlling blockchain nodes. Hereinafter, owning or substantially controlling something may be simply referred to as “owning” it. In addition, a person, a corporation, or the like who owns something may be referred to as an “owner”.

Further, there are “end users” who issue and distribute tokens using the system infrastructure of the consortium. The end user owns no blockchain nodes, and uses a terminal such as a PC or a mobile to access the blockchain network for transactions.

When a new token is created, the consortium owner or the end user designs specifications of the token, and the consortium owner develops a program (that is, a smart contract) of the token on the basis of the specifications. Then, the consortium participant company deploys the program of the token in the blockchain network so that the end user can issue and distribute the token.

As a technology for deploying a smart contract such as a token in a blockchain, for example, a system and method for managing a blockchain cloud service (PTL 1) is known. In this system, a function of constructing a blockchain node and deploying a smart contract is provided as a service, and thereby a mechanism that allows a system administrator of a consortium participant company to operate the smart contract without manual work is provided.

### CITATION LIST

### Patent Literature

PTL 1: JP 2020-512757 A

### SUMMARY OF INVENTION

### Technical Problem

However, in the above conventional example, when the consortium participant company deploys the token in the blockchain, since the end user owns no blockchain nodes, the token can be deployed without an agreement of the end user on the blockchain network although the end user is responsible for issuing, delivering, and distributing the token.

Therefore, the present invention has been made in view of the above problems, and an object of the present invention is to make it essential for the end user to consent that the end user entrusts operation of a token to a blockchain network participant organization and that the organization to which the operation is entrusted performs a deployment operation, and make it possible to confirm that the system is operated according to the consent of the end user.

### Solution to Problem

One aspect of the present invention is a token management method for deploying a token based on a request from an end user by using an information processing system including a plurality of computers including an arithmetic device and a memory device, the information processing system including a token registration unit, a user management unit, a token management unit, a policy management unit, and a life cycle management unit. The token registration unit registers a test result, an electronic signature, and a hash of a token program in the memory device as repository information, the electronic signature and the hash being confirmation evidence. The user management unit records consent of the end user, as a trail, to entrust operation of the token to a virtual organization, and registers the consent in the memory device as user information management information. The token management unit records consent of the end user, as a trail, to deploy the token, and registers the consent in the memory device as token information management information. The policy management unit updates a policy definition registered in the memory device such that a signature of the virtual organization to which the operation is entrusted is essential for deployment of the token. The life cycle management unit, when receiving a deployment request for a token, refers to the policy definition, and deploys the token in a case where the deployment request satisfies the policy definition.

Another aspect of the present invention is an end-user management apparatus connected via a network to a plurality of token processing apparatuses that deploy a token. This apparatus includes a user management unit. The user management unit is configured to, when receiving a user registration request from a user other than an owner of the token processing apparatuses or the end-user management apparatus, register a set of information for specifying the user and information for specifying, as an agent, an owner of at least one of the token processing apparatuses and the end-user management apparatus in a user information management table, and store the user information management table as a distributed ledger.

Another aspect of the present invention is one of the token processing apparatuses connected via the network to the end-user management apparatus described above. This apparatus stores a user information management table in which a set of information for specifying the user, information for specifying, as an agent, an owner of at least one of the token processing apparatuses and the end-user management apparatus, and information for specifying an available token is registered. The user information management table constitutes a distributed ledger to which a blockchain is applied together with a user information management table stored in another one of the token processing apparatuses.

### Advantageous Effects of Invention

Therefore, the present invention makes it possible, in a token economy, to deploy a token with consent of an end user and verify evidence thereof so that transparency of the token economy can be improved as viewed from the end user.

Details of at least one implementation of the subject matter disclosed herein are set forth in the accompanying drawings and the following description. The other features, aspects, and advantageous effects of the disclosed subject matter will be apparent from the following disclosure, drawings, and claims.

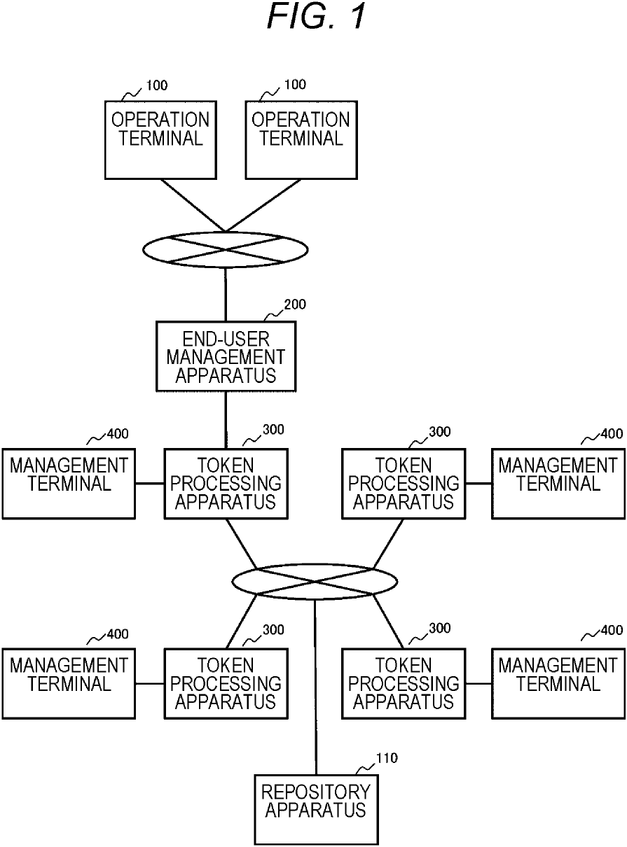

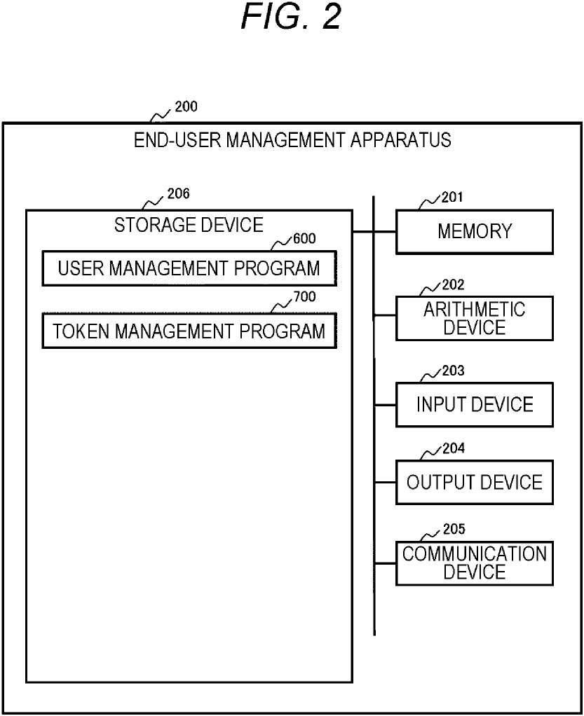

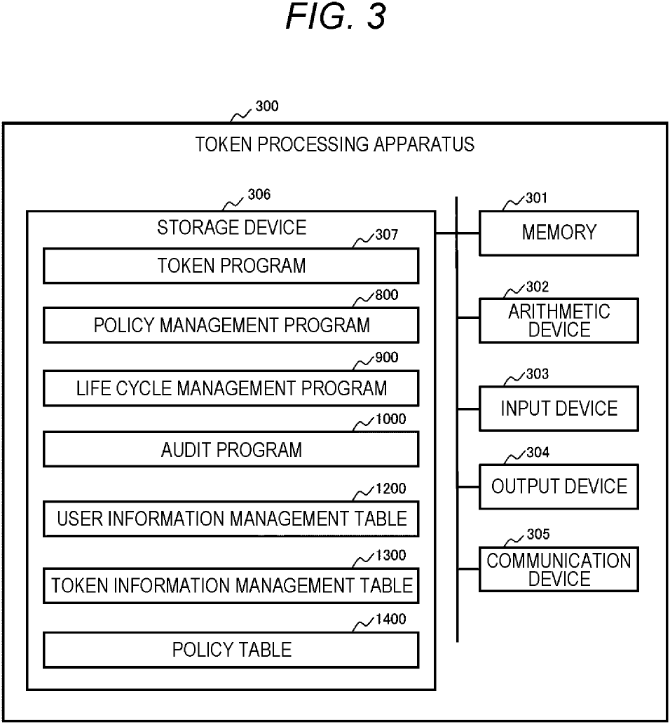

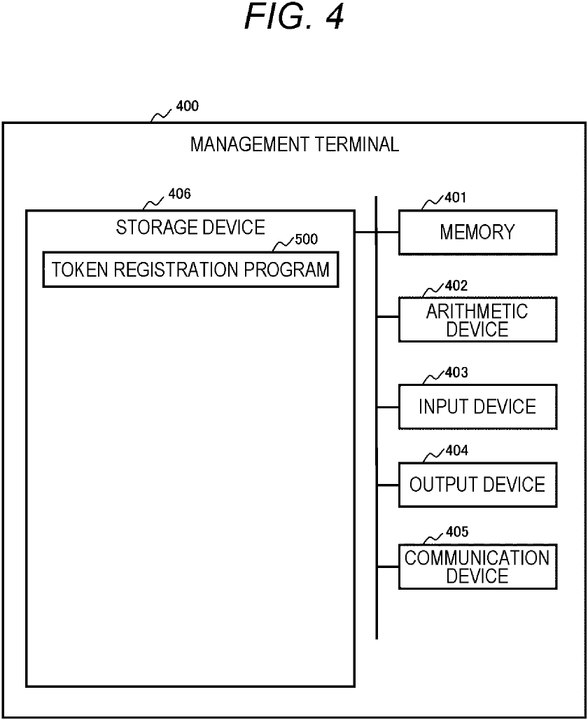

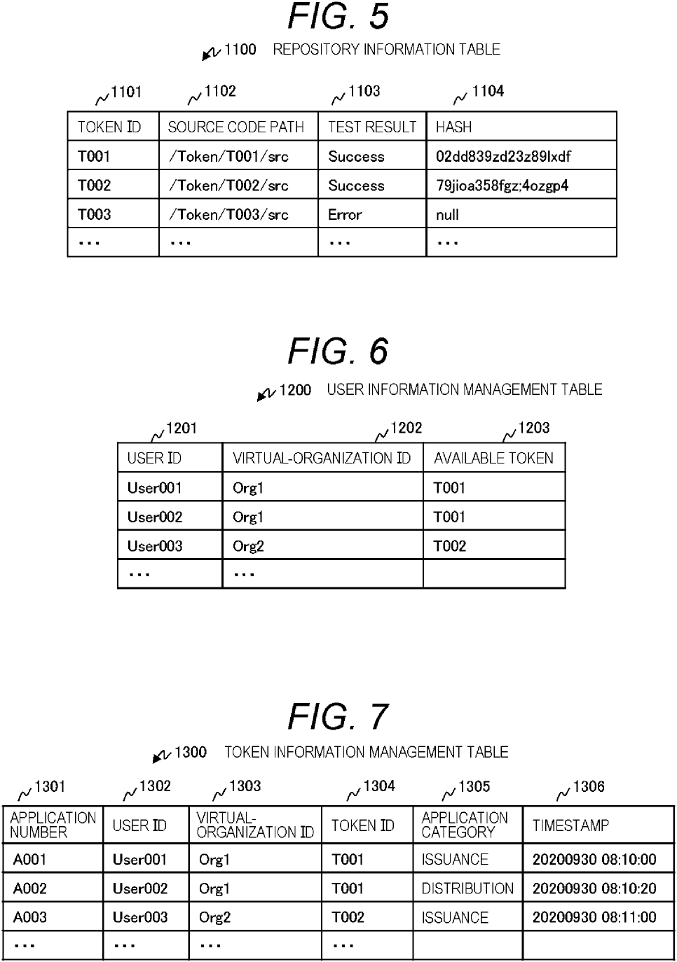

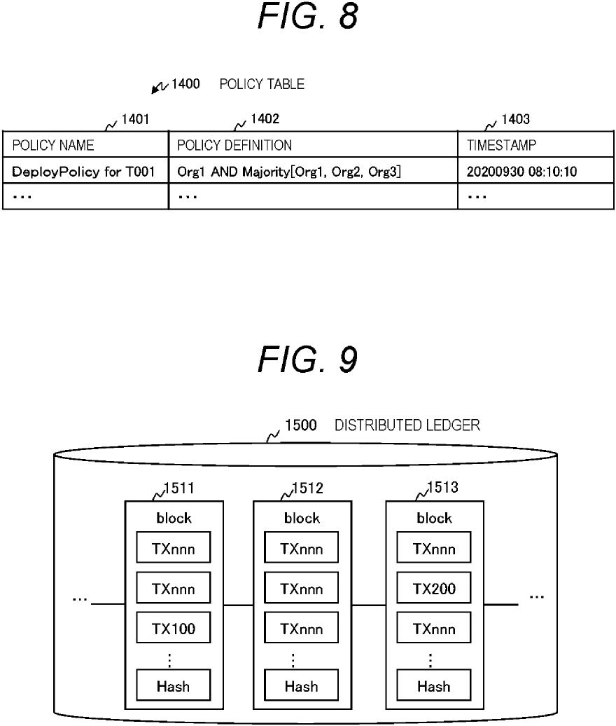

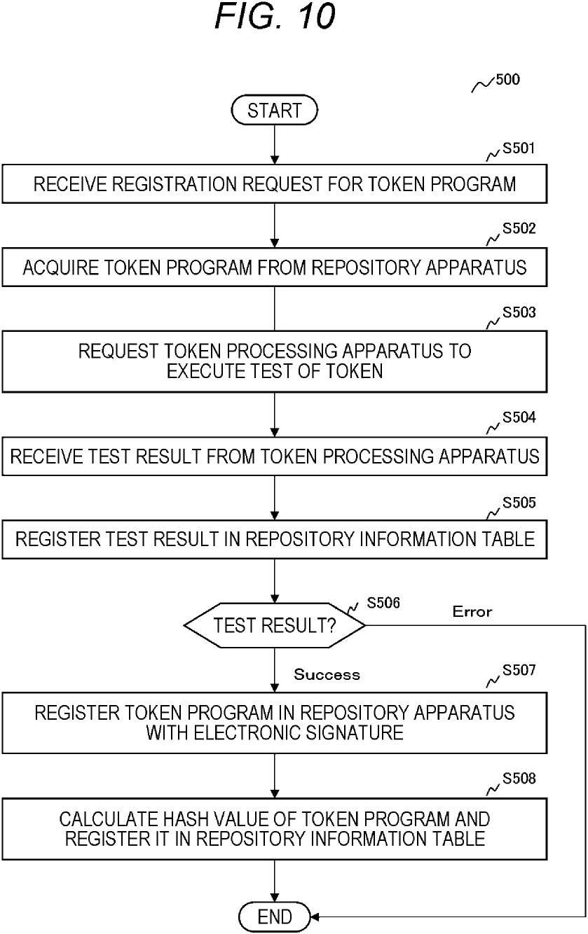

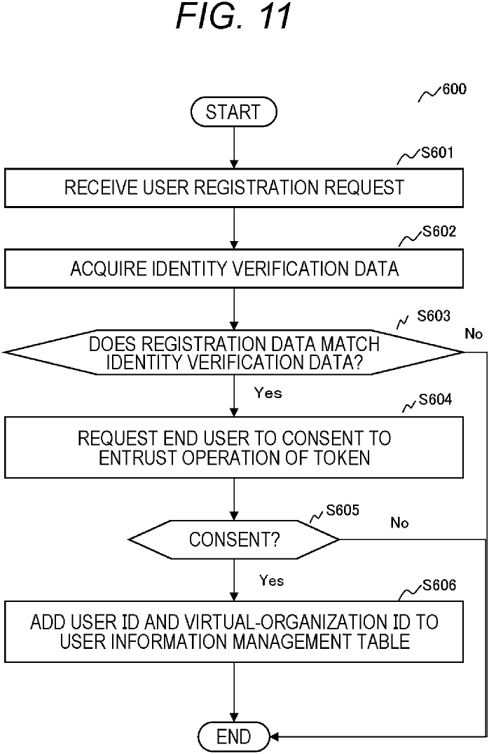

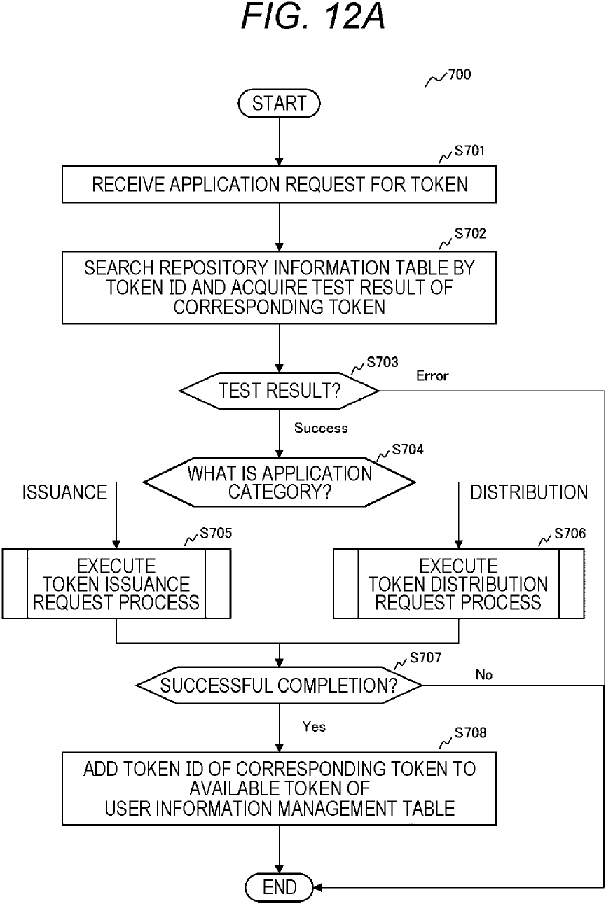

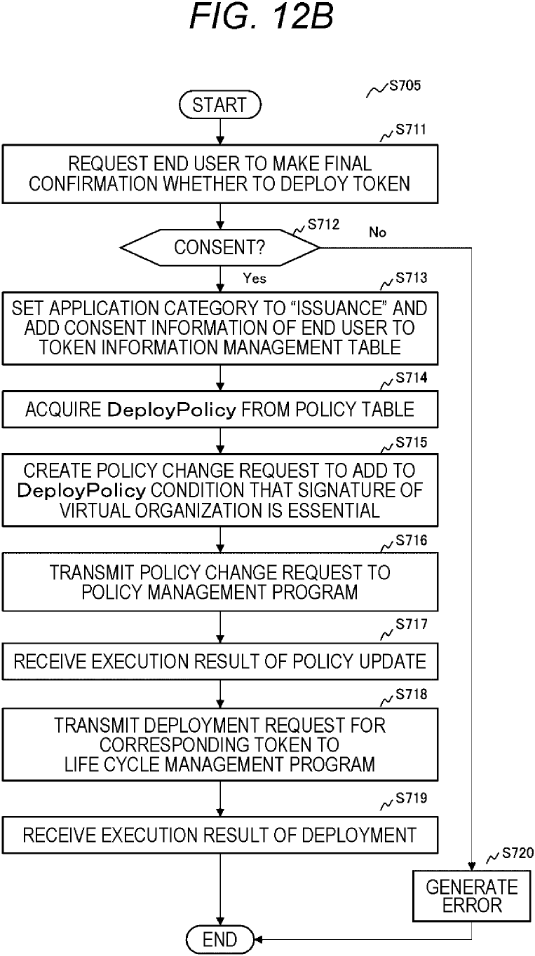

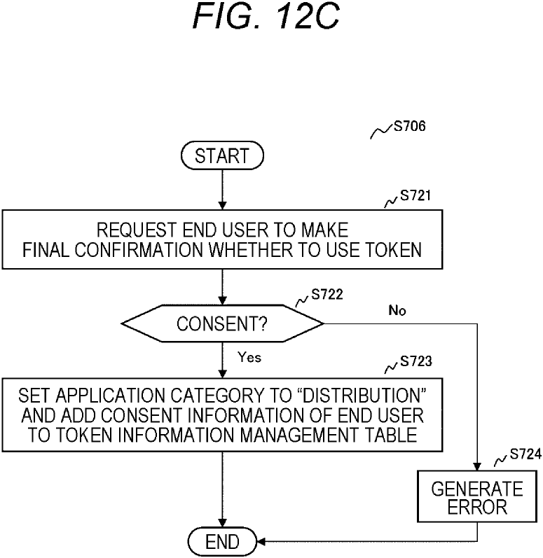

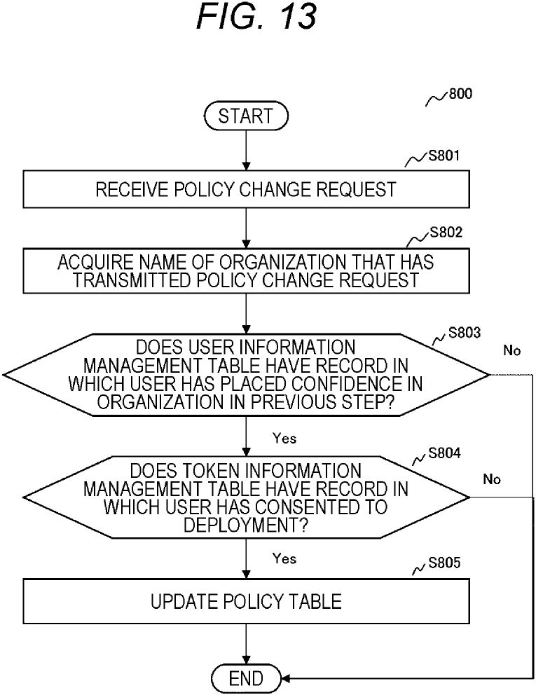

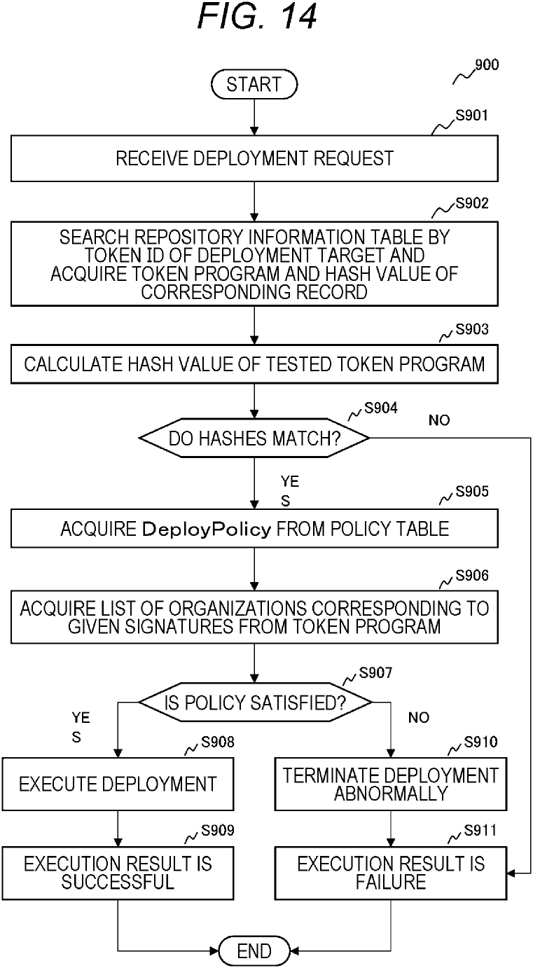

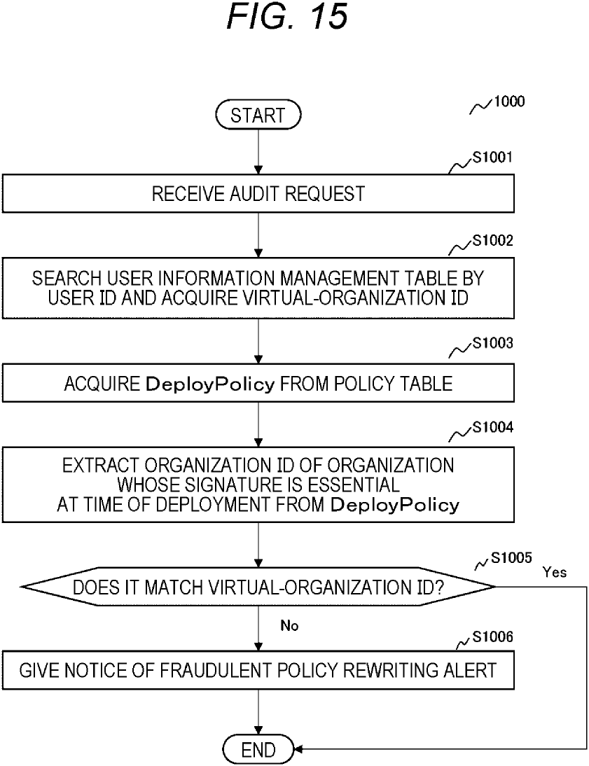

### BRIEF DESCRIPTION OF DRAWINGS

[FIG. 1] FIG. 1 is a block diagram illustrating an example of an apparatus configuration of a token management system according to a first embodiment of the present invention.

[FIG. 2] FIG. 2 is a block diagram illustrating an example of an end-user management apparatus according to the first embodiment of the present invention.

[FIG. 3] FIG. 3 is a block diagram illustrating an example of a token processing apparatus according to the first embodiment of the present invention.

[FIG. 4] FIG. 4 is a block diagram illustrating an example of a management terminal according to the first embodiment of the present invention.

[FIG. 5] FIG. 5 is a diagram illustrating an example of a repository information table according to the first embodiment of the present invention.

[FIG. 6] FIG. 6 is a diagram illustrating an example of a user information management table according to the first embodiment of the present invention.

[FIG. 7] FIG. 7 is a diagram illustrating an example of a token information management table according to the first embodiment of the present invention.

[FIG. 8] FIG. 8 is a diagram illustrating an example of a policy table according to the first embodiment of the present invention.

[FIG. 9] FIG. 9 is a diagram illustrating an example of a distributed ledger according to the first embodiment of the present invention.

[FIG. 10] FIG. 10 is a flowchart illustrating an example of a token registration program executed in the management terminal according to the first embodiment of the present invention.

[FIG. 11] FIG. 11 is a flowchart illustrating an example of a user management program executed in the end-user management apparatus according to the first embodiment of the present invention.

[FIG. 12A] FIG. 12A is a flowchart illustrating an example of a token management program executed in the end-user management apparatus according to the first embodiment of the present invention.

[FIG. 12B] FIG. 12B is a flowchart illustrating an example of a token issuance request process executed in the end-user management apparatus according to the first embodiment of the present invention.

[FIG. 12C] FIG. 12C is a flowchart illustrating an example of a token distribution request process executed in the end-user management apparatus according to the first embodiment of the present invention.

[FIG. 13] FIG. 13 is a flowchart illustrating an example of a policy management program executed in the token processing apparatus according to the first embodiment of the present invention.

[FIG. 14] FIG. 14 is a flowchart illustrating an example of a life cycle management program executed in the token processing apparatus according to the first embodiment of the present invention.

[FIG. 15] FIG. 15 is a flowchart illustrating an example of an audit program executed in the token processing apparatus according to the first embodiment of the present invention.

### DESCRIPTION OF EMBODIMENTS

Hereinafter, embodiments of the present invention will be described with reference to the accompanying drawings. However, the present invention is not to be construed as being limited to the description of the embodiments described below. Those skilled in the art can easily understand that a specific configuration of the present invention can be changed without departing from the spirit or gist of the present invention.

In the configurations of the embodiments described below, the same reference signs may be commonly used for the same portions or portions having similar functions in different figures, and redundant description may be omitted.

In a case where there are multiple elements having the same or similar functions, they may be denoted with the same reference signs with different subscripts for description. However, in a case where it is not necessary to distinguish the multiple elements, the subscripts may be omitted in the description.

Expressions such as “first”, “second”, and “third” in the present specification and the like are added to identify constituent elements, and do not necessarily limit the number, order, or contents thereof. In addition, the reference numerals for identifying constituent elements are used in each context, and a reference numeral used in one context does not necessarily indicate the same configuration in another context. Furthermore, a constituent element identified by a certain reference numeral is not hindered from concurrently serving a function of a constituent element identified by another reference numeral.

A position, size, shape, range, and the like of each component illustrated in the drawings and the like may differ from the actual position, size, shape, range, and the like for the purpose of facilitating understanding of the invention. Thus, the present invention is not necessarily limited to the positions, sizes, shapes, ranges, and the like disclosed in the drawings and the like.

The publications, patents, and patent applications cited herein form a part of the description of the present specification.

The constituent elements expressed in the singular herein include the plural unless the context clearly dictates otherwise.

In one embodiment, there is provided a token management system including: a management terminal including a processor and a memory; an end-user management apparatus including a processor and a memory; and a token processing apparatus including a processor and a memory. In the token management system, the management terminal registers a test result, an electronic signature, and a hash of a token program in a repository, the electronic signature and the hash being confirmation evidence. The end-user management apparatus records and shares consent of an end user, as a trail, to entrust operation of a token to assign the end user a virtual organization, as well as records and shares consent of the end user, as a trail, to deploy the token. The token processing apparatus updates a policy definition such that a signature of the virtual organization to which the operation is entrusted is essential for deployment of the token, deploys the token only in a case where a deployment request satisfies the policy definition, and verifies that the policy definition is described as agreed by the end user.

### First Embodiment

FIG. 1 is a block diagram illustrating an example of an apparatus configuration of a token management system according to a first embodiment of the present invention. The token management system of the first embodiment relates to a consortium including a consortium owner, a consortium participant company, an end user, and the like. The consortium participant company is, for example, a financial institution that mediates a transaction, an audit institution that audits a transaction result, or the like. The end user is, for example, a token issuing company, an individual investor, an institutional investor, or the like.

In this consortium, a test result of a token program and an electronic signature and a hash of the token program, which are confirmation evidence, are registered in a repository, and consent of the end user to entrust operation of the token is recorded and shared as a trail on the system. The end user is assigned a virtual organization. Consent of the end user to deploy the token is recorded and shared as a trail, and a policy definition is updated such that a signature of the virtual organization to which the operation is entrusted on the system is essential for deployment of the token. Then, the token is deployed only in a case where a deployment request satisfies the policy definition, and it is verified that the policy definition is described as agreed by the end user.

The token management system includes at least one operation terminal 100 owned by an end user such as an issuer company or an investor, an end-user management apparatus 200 that accepts a request from the operation terminal 100 and performs management and transactions of a token as an agent of the end user, a plurality of token processing apparatuses 300 that executes and records deployment and transactions of a token, a plurality of management terminals 400 that manages the token processing apparatuses, and a repository apparatus 110 that stores a token program.

The issuing company and investor (end user) and the financial institution and audit institution (consortium participant company) form a community where tokens such as, for example, digitized corporate bonds are issued and distributed, and the end-user management apparatus 200, the token processing apparatuses 300, and the management terminals 400 are arranged in the companies included in the community. For example, the end user owns the operation terminal 100. The consortium participant company or the consortium owner owns the end-user management apparatus 200, the token processing apparatus 300, the management terminal 400, and the repository apparatus 110.

### <End-User Management Apparatus>

FIG. 2 is a block diagram illustrating an example of the end-user management apparatus 200. The end-user management apparatus 200 is a computer including a memory 201, an arithmetic device 202, an input device 203, an output device 204, a communication device 205, and a storage device 206. Hereinafter, the memory and the storage device may be collectively referred to as a memory device.

The storage device 206 stores a user management program 600 for verifying the identity of the end user and recording and sharing consent of the end user, as a trail, to entrust operation of a token to a virtual organization, and a token management program 700 for recording and sharing consent of the end user, as a trail, to deploy the token and requesting deployment of the token as an agent of the end user.

Here, the “agent of the end user” means that the end-user management apparatus 200, which is not owned by the end user, requests deployment of the token with a request from the end user as a trigger.

The input device 203 includes, for example, a keyboard and mouse or a touch panel. The output device 204 includes, for example, a display. The communication device 205 is connected to a network to communicate with another computer.

The user management program 600 and the token management program 700 are loaded into the memory 201 and executed by the arithmetic device 202.

The arithmetic device 202 works as a functional unit that provides a predetermined function by executing processing according to a program of each functional unit. For example, the arithmetic device 202 functions as a user management unit by executing processing according to the user management program 600. The same applies to another program. In addition, the arithmetic device 202 also works as a functional unit that provides respective functions of multiple processes executed by each program. A computer and computer system is an apparatus and system including these functional units.

### <Token Processing Apparatus>

FIG. 3 is a block diagram illustrating an example of the token processing apparatus 300. The token processing apparatus 300 is a computer including a memory 301, an arithmetic device 302, an input device 303, an output device 304, a communication device 305, and a storage device 306.

The storage device 306 stores a token program 307 for performing transactions such as issuance and distribution of a token, a policy management program 800 for managing a system operation policy in the token processing apparatus 300, a life cycle management program 900 for performing deployment only in a case where a deployment request for the token program satisfies a policy definition, an audit program 1000 for verifying validity of the operation policy, a user information management table 1200 in which information of the end user is recorded, a token information management table 1300 in which a history of token application from the end user is recorded, and a policy table 1400 for managing the operation policy.

The input device 303 includes, for example, a keyboard and mouse or a touch panel. The output device 304 includes, for example, a display. The communication device 305 is connected to the network to communicate with another computer.

The token program 307, the policy management program 800, the life cycle management program 900, and the audit program 1000 are loaded into the memory 301 and executed by the arithmetic device 302.

The arithmetic device 302 works as a functional unit that provides a predetermined function by executing processing according to a program of each functional unit. For example, the arithmetic device 302 functions as a policy management unit by executing processing according to the policy management program 800. The same applies to another program. In addition, the arithmetic device 302 also works as a functional unit that provides respective functions of multiple processes executed by each program. A computer and computer system is an apparatus and system including these functional units.

The user information management table 1200, the token information management table 1300, and the policy table 1400 are a distributed ledger 1500 to be described later, which is a management ledger distributed and shared among the participants of the token economy. In the first embodiment, they are stored in the token processing apparatuses 300 held by the consortium owner, the financial institution, and the audit institution, so that the user information, the token information, and the policy are shared.

### <Management Terminal>

FIG. 4 is a block diagram illustrating an example of the management terminal 400. The management terminal 400 is a computer including a memory 401, an arithmetic device 402, an input device 403, an output device 404, a communication device 405, and a storage device 406.

The storage device 406 stores a token registration program 500 for executing a test of a token program and registering a test result and an electronic signature in the repository apparatus 110.

The input device 403 includes, for example, a keyboard and mouse or a touch panel. The output device 404 includes, for example, a display. The communication device 405 is connected to the network to communicate with another computer.

The token registration program 500 is loaded into the memory 401 and executed by the arithmetic device 402.

The arithmetic device 402 works as a functional unit that provides a predetermined function by executing processing according to a program of each functional unit. For example, the arithmetic device 402 functions as a token registration unit by executing processing according to the token registration program 500. The same applies to another program. In addition, the arithmetic device 402 also works as a functional unit that provides respective functions of multiple processes executed by each program. A computer and computer system is an apparatus and system including these functional units.

Each computer described above may be configured as a single computer, or an arbitrary portion thereof may be configured using another computer connected by the network. In the embodiment, the function equivalent to each functional unit configured by software or a program can also be realized by hardware such as a field programmable gate array (FPGA) or an application specific integrated circuit (ASIC).

### <Data>

FIG. 5 is a diagram illustrating an example of a repository information table 1100. The repository information table 1100 is managed in the repository apparatus 110. Being managed means being able to be accessed for recording, change, reading, and the like. The repository apparatus 110 stores a source code of a token program, which is a product when multiple organizations and developers cooperatively develop one system, for example.

The repository information table 1100 includes Token ID 1101, Source Code Path 1102, Test Result 1103, and Hash 1104 in one entry.

Token ID 1101 stores a name or an identifier for uniquely identifying a token. Source Code Path 1102 stores a directory path representing a location in the repository apparatus 110 in which a program of the token identified by the token ID 1101 is located. Test Result 1103 stores a test result of the token program. Hash 1104 stores a hash value of the token program.

FIG. 6 is a diagram illustrating an example of the user information management table 1200. The user information management table 1200 is distributed and shared among the participants of the consortium, and is managed in the token processing apparatuses 300.

The user information management table 1200 includes User ID 1201, Virtual-Organization ID 1202, and Available Token 1203 in one entry. User ID 1201 stores a name or an identifier representing an end user such as an issuer or an investor. Note that the user ID 1201 is a unique value in the consortium.

Virtual-Organization ID 1202 stores a value uniquely specifying an organization in the consortium (for example, the consortium participant company or the consortium owner) to which operation of a token is entrusted by the user identified by the user ID 1201. Available Token 1203 stores a list of token IDs as a list of tokens available to the end user.

FIG. 7 is a diagram illustrating an example of the token information management table 1300. The token information management table 1300 is distributed and shared among the participants of the consortium, and is managed by the token processing apparatuses 300.

The token information management table 1300 includes Application Number 1301, User ID 1302, Virtual-Organization ID 1303, Token ID 1304, Application Category 1305, and Timestamp 1306 in one entry.

Application Number 1301 stores a case number issued each time an application for a token is accepted. User ID 1302 stores the user ID of an end user who has applied for the case. Virtual-Organization ID 1303 stores the ID of a virtual organization to which operation is entrusted by the end user who has applied for the case. Token ID 1304 stores the token ID representing the token which is applied for in the case. Application Category 1305 stores a code representing an application purpose of the case, and the code value is Issuance or Distribution. Timestamp 1306 stores the application submission date and time for the case.

FIG. 8 is a diagram illustrating an example of the policy table 1400. The policy table 1400 is distributed and shared among the participants of the consortium, and is managed by the token processing apparatuses 300.

The policy table 1400 includes Policy Name 1401, Policy Definition 1402, and Timestamp 1403 in one entry. One entry corresponds to one token and defines a policy of the token.

Policy Name 1401 stores a name or an identifier for uniquely identifying a system operation setting policy. Policy Definition 1402 stores rule definition information of the policy represented by the policy name. Timestamp 1403 stores the last update date and time of the policy.

FIG. 9 is a diagram illustrating an example in which the user information management table 1200, the token information management table 1300, and the policy table 1400 are shared as the distributed ledger 1500. In the example illustrated in the first embodiment, a blockchain is applied to the distributed ledger 1500 and, assuming that one entry illustrated in FIGS. 6, 7, and 8 is one transaction, a plurality of transactions and a hash value constitute each of blocks 1511, 1512, and 1513.

In each of the blocks 1511, 1512, and 1513, the hash value of a block is calculated from contents of the transactions in this block and the hash value of the immediately preceding block. The contents of the transactions and the hash value are held in each of the blocks 1511, 1512, and 1513.

The technology of blockchain, which is well known, is a distributed ledger management system combining a P2P network, a consensus algorithm, smart contracts, anti-counterfeiting, and encryption technology.

In the example illustrated in the first embodiment, advantage is taken of decentralization, transparency, tamper resistance, fault tolerance, and automatic execution (automatic transactions) among the features of the blockchain.

Firstly, decentralization indicates that monopoly on management of data by a specific participant is prohibited, and each participant in the blockchain is allowed to manage the data.

Next, transparency indicates that information generated by each participant is published to all the participants and is shared by all the participants. The participants in the token community can view all information, and consistency of recorded information is guaranteed.

In terms of tamper resistance, the participants generate transactions and the transactions are linked with each other in a chain shape on the basis of an electronic signature and a hash value, thereby preventing tampering with data. In addition, publishing information generated by each participant can suppress motivation to tamper with data.

Fault tolerance is to prevent data from being damaged or lost even if a failure occurs in some participants by each participant in the blockchain holding the data or a copy of the data.

Automatic execution (automatic transactions) indicates that determination results on a plurality of necessary conditions are aggregated and then a transaction or issuance of information is executed. Alternatively, it indicates that issued information is efficiently agreed on.

Note that, in the first embodiment, description is given for the example in which the hash value of a block is calculated from the contents of the transactions and the hash value of the immediately preceding block, but the present invention is not limited thereto.

For example, each block may store hash values of the contents of the transactions and identifiers of the transactions instead of the contents of the transactions. In this case, the hash value of a block can be calculated from the hash value of the immediately preceding block, the hash values of the contents of the transactions, and the identifiers of the transactions.

It is then sufficient if transaction contents are held by the participants. Alternatively, an apparatus that stores the transaction contents of the participants may be provided. In this case, it is possible to keep each transaction content private, and provide a transaction content between participants to limited participants.

### <Processing>

FIG. 10 is a flowchart illustrating an example of the token registration program 500 in the management terminal 400. This process starts when a registration request for a token program is received. It is assumed that the token ID 1101 and the source code path 1102 of the repository information table 1100 have been registered before the registration request for the token program.

In the following description, the token registration program 500 is regarded as a subject that performs processing, but the arithmetic device 402 may be regarded as the processing subject. For the sake of convenience, the processing subject may be referred to as a token registration unit.

The token registration program 500 receives a registration request for a token program from the management terminal 400 (S501). A registration request message includes, for example, a token ID. The token registration program 500 searches the repository information table 1100 for an entry having the token ID.

Next, the token registration program 500 acquires the token program from the repository apparatus 110 on the basis of the source code path of the repository information table (S502). The token registration program 500 stores the token program 307 in the token processing apparatus 300 and requests the token processing apparatus to execute a test of the token (S503). The token program 307 is executed and tested on the token processing apparatus 300. The token registration program 500 receives a test result from the token processing apparatus (S504). The token registration program 500 registers the test result 1103 in the repository information table 1100 (S505).

Next, the token registration program 500 determines whether the test result indicates successful completion (S506). If the test result is Success, the process proceeds to S507, and if it is Error, the process ends.

The token registration program 500 registers the token program indicated by the source code path 1102 of the repository information table 1100 into the repository apparatus 110 with an electronic signature (S507). In addition, the token registration program 500 calculates a hash value of the token program and registers the hash value in the repository information table 1100 (S508).

FIG. 11 is a flowchart illustrating an example of the user management program 600 in the end-user management apparatus 200. This process starts when a user registration request is received.

In the following description, the user management program 600 is regarded as a subject that performs processing, but the arithmetic device 202 may be regarded as the processing subject. For the sake of convenience, the processing subject may be referred to as a user management unit.

The user management program 600 receives a user registration request from the operation terminal 100 (S601). A user registration request message includes, for example, a name and profile information of the user. The user is, for example, an end user such as a token issuing company or an investor.

The user management program 600 acquires identity verification data (S602). The identity verification data is a document, such as a copy of a driver’s license or a passport, for confirming that the name and profile of the user are correct.

The user management program 600 determines whether the registration data included in the user registration request message of S601 matches the identity verification data acquired in S602 (S603). If Yes, the process proceeds to S604, and if No, the process ends.

Next, the user management program 600 requests the end user to consent to entrust operation of a token (S604). The end user expresses an intention of consent or dissent via the operation terminal 100. The user management program 600 determines whether the consent has been obtained (S605). If Yes, the process proceeds to S606, and if No, the process ends.

The user management program 600 adds the user ID and the virtual-organization ID to the user information management table 1200 in the token processing apparatus 300. The virtual-organization ID is an organization name or an organization ID for identifying the organization to which the end user entrusts the operation of a token. The information such as the organization name or the organization ID for specifying the virtual organization is included in the user registration request. Alternatively, the organization to which the end user entrusts the operation may be registered in advance. For example, in a case where the consortium owner operates the end-user management apparatus 200, the organization ID of the consortium owner may be assigned to the virtual-organization ID. Alternatively, the organization ID of a blockchain participant organization other than the consortium owner may be assigned to the virtual-organization ID. For example, the virtual organization to which the operation is entrusted may be selected from the blockchain participant organizations other than the consortium owner and grouped by end user attributes. For example, assignment to the virtual-organization ID may be performed depending on the country or region where the end user resides. The virtual organization is, for example, an owner who owns at least one set of the token processing apparatus 300 and the management terminal 400.

FIG. 12A is a flowchart illustrating an example of the token management program 700 in the end-user management apparatus 200. This process starts when the end-user management apparatus 200 accepts an application request for a token from the operation terminal 100.

In the following description, the token management program 700 is regarded as a subject that performs processing, but the arithmetic device 202 may be regarded as the processing subject. For the sake of convenience, the processing subject may be referred to as a token management unit.

The token management program 700 accepts an application request for a token from the operation terminal 100 (S701). The application request for a token includes, for example, a user ID of an end user who applies for the token and a token ID. The token management program 700 extracts the token ID from the request message of S701, searches the repository information table 1100 by the token ID, and acquires the test result 1103 of the corresponding token (S502). The test result is a result of operation verification of the corresponding token program performed by a constituent organization (specifically, the token processing apparatus 300) of the consortium. The token management program 700 determines whether the test result indicates successful completion (S703). If the test result is Success, the process proceeds to S704, and if it is Error, the process ends.

Next, the token management program 700 determines the application category of the request message accepted in S701 (S704). If the processing category is Issuance, the process proceeds to S705, and if it is Distribution, the process proceeds to S706.

The token management program 700 executes a token issuance request process (S705). Details of this process will be described later with reference to S711 to S720 illustrated in FIG. 12B.

The token management program 700 executes a token distribution request process (S706). Details of this process will be described later with reference to S721 to S724 illustrated in FIG. 12C.

Next, the token management program 700 determines whether an execution result of S705 and S706 indicates successful completion (S707). If Yes, the process proceeds to S708, and if No, the process ends.

The token management program 700 adds the token ID of the corresponding token to Available Token 1203 of the user information management table 1200 (S708).

FIG. 12B illustrates S711 to S720 for performing the token issuance request process in the flowchart illustrating an example of the token management program 700 in the end-user management apparatus 200.

First, the token management program 700 requests the end user to make a final confirmation whether to deploy the token (S711). The token management program 700 acquires a response from the end user and determines whether consent has been obtained (S712). The request and the response are made via the operation terminal 100. If Yes, the process proceeds to S713, and if No, the process proceeds to S720.

The token management program 700 sets the application category to “Issuance” and, together with a uniquely determined application number 1301, a user ID 1302, a virtual-organization ID 1303, a token ID 1304, and a timestamp 1306 which are consent information of the end user, adds an entry to Application Category 1305 of the token information management table 1300 (S713). The user ID 1302 and the token ID 1304 are obtained from the application request for the token. The virtual-organization ID 1303 is specified from the user information management table 1200 on the basis of the user ID 1302 and the token ID 1304. The timestamp 1306 is a time when the application request for the token is received or a time when the entry is added.

Next, the token management program 700 acquires DeployPolicy for the token ID from the policy table 1400 (S714). The acquired policy definition is, for example, ‘Majority [Org1, Org2, Org3]’ for the token T001. This definition means that consensus building at the time of deployment of the token requires signatures of a majority of the three organizations Org1, Org2, and Org3. Org1, Org2, and Org3 are consortium participant companies that own respective token processing apparatuses 300 and are responsible for the system operation of the blockchain network. A default policy definition is to get signatures of a majority of the node owner organizations for reaching an entire system consensus on whether to deploy a token program.

Next, the token management program 700 creates a policy change request to add, to DeployPolicy, a condition that a signature of the virtual organization is essential (S715). The updated policy definition is, for example, ‘Org1 AND Majority [Org1, Org2, Org3]’. This definition means that consensus building at the time of deployment of the token requires a signature of Org1 as well as signatures of a majority of the three organizations Org1, Org2, and Org3. The default policy is intended for stability of the entire system and requires agreement of a majority of the organizations. In addition to that, in order to reflect agreement of the end user on whether the token program can be deployed, the policy definition is updated such that the signature of the virtual organization to which the operation of the token is entrusted from the end user, that is, Org1 as an agent, is essential. The signature of Org1 is essential, so that signatures of a majority of the organizations alone cannot deploy a new token.

The token management program 700 of the end-user management apparatus 200 transmits the policy change request to the policy management program 800 in the token processing apparatus 300 (S716). The token management program 700 receives an execution result of policy update (S717).

Next, the token management program 700 in the end-user management apparatus 200 transmits a deployment request for the token to the life cycle management program 900 in the token processing apparatus 300 (S718). The token management program 700 receives an execution result of deployment (S719).

In a case where the agreement for deployment has not been obtained from the end user in S712, the token management program 700 generates error information (S720).

FIG. 12C illustrates S721 to S724 for performing the token distribution request process in the flowchart illustrating an example of the token management program 700 in the end-user management apparatus 200.

First, the token management program 700 requests the end user to make a final confirmation whether to use the token (S721). The token management program 700 acquires a response from the end user and determines whether consent has been obtained (S722). The request and the response are made via the operation terminal 100. If Yes, the process proceeds to S723, and if No, the process proceeds to S724.

The token management program 700 sets the application category to “Distribution” and, together with a uniquely determined application number 1301, a user ID 1302, a virtual-organization ID 1303, a token ID 1304, and a timestamp 1306 which are consent information of the end user, adds an entry to the token information management table 1300 (S723). The virtual-organization ID 1303 is specified from the user information management table 1200 on the basis of the user ID 1302 and the token ID 1304. The other steps are the same as those in the “Issuance” process.

In a case where the agreement for use of the token has not been obtained from the end user, the token management program 700 generates error information (S724).

FIG. 13 is a flowchart illustrating an example of the policy management program 800 in the token processing apparatus 300. This process starts when a policy change request is received.

In the following description, the policy management program 800 is regarded as a subject that performs processing, but the arithmetic device 302 may be regarded as the processing subject. For the sake of convenience, the processing subject may be referred to as a policy management unit.

The policy management program 800 receives a policy change request from the token management program 700 in the end-user management apparatus 200 (S801). A policy change request message includes, for example, a token ID and a virtual-organization ID of an agent. The policy management program 800 acquires the name of the organization that has transmitted the policy change request (S802).

Next, the policy management program 800 determines whether the user information management table 1200 has a record in which a user has confided the token to the virtual organization of which name is acquired in the previous step S802 (S803). If Yes, the process proceeds to S804, and if No, the process ends.

Next, the policy management program 800 determines whether the token information management table 1300 has a record in which the user has consented to deploy the token (S804). If Yes, the process proceeds to S805, and if No, the process ends.

Next, the policy management program 800 updates the policy table 1400 related to the token (S805).

As described above, when receiving a policy change request, the policy management unit acquires the information for specifying a token related to the policy change request and the information for specifying an organization that has transmitted the policy change request on the basis of the policy change request. Then, the policy management unit refers to the user information management table and extracts an entry associated with the organization that has transmitted the policy change request for the token related to the policy change request. Then, the policy management unit refers to the token information management table, confirms whether the user specified by the entry has given consent to issue the token related to the policy change request, and changes the policy table only in a case where the consent can be confirmed.

FIG. 14 is a flowchart illustrating an example of the life cycle management program 900 in the token processing apparatus 300. This process starts when a deployment request is received.

In the following description, the life cycle management program 900 is regarded as a subject that performs processing, but the arithmetic device 302 may be regarded as the processing subject. For the sake of convenience, the processing subject may be referred to as a life cycle management unit.

First, the life cycle management program 900 receives a deployment request from the token management program 700 in the end-user management apparatus 200 (S901).

The life cycle management program 900 searches the repository information table 1100 by the token ID of the deployment target, and acquires the token program and the hash value of the corresponding record (S902).

Next, the life cycle management program 900 calculates the hash value of the tested token program (S903). The life cycle management program 900 determines whether the hash value which has been registered in the repository and is acquired in S902 matches the hash value which is calculated in S903 (S904). If Yes, the process proceeds to S905, and if No, the process proceeds to S911.

Here, the reason for confirming the hash match is to verify that the token program has not been changed or tampered with between the time the token registration program 500 executes the test and the time the deployment request is received. In a case where the hash values do not match, the token program has been changed or tampered with, so that deployment is not performed. The life cycle management program 900 is executed in each organization in the consortium, and thus each organization can check the token program. In addition, since the end user has entrusted operation of the token to a virtual organization, the virtual organization can verify change or tampering of the token program.

Next, the life cycle management program 900 acquires DeployPolicy for the token related to the deployment request from the policy table 1400 (S905). Further, the life cycle management program 900 acquires, from the token program acquired in S902, a list of organizations corresponding to the given signatures (S906). Here, the signature is an electronic signature given by the token registration program 500 in the management terminal 400 when the test of the token program is successfully completed. The token registration program 500 is executed in each organization in the consortium, and thus electronic signatures of multiple organizations are given.

Next, the life cycle management program 900 determines whether the list of organizations acquired in S906 satisfies the policy definition acquired in S905 (S907). If Yes, the process proceeds to S906, and if No, the process proceeds to S910.

In a case where the policy definition is satisfied, the life cycle management program 900 executes deployment of the token program (S908). The life cycle management program 900 returns a response indicating that the execution result is successful (S909).

On the other hand, in a case where the policy definition is not satisfied, the life cycle management program 900 terminates the deployment of the token program abnormally (S910). The life cycle management program 900 returns a response indicating that the execution result is failure (S911).

FIG. 15 is a flowchart illustrating an example of the audit program 1000 in the token processing apparatus 300. This process starts when an audit request is received. The audit request is issued in response to, for example, an input from the input device 303 or a request from the operation terminal 100 or the management terminal 400.

In the following description, the audit program 1000 is regarded as a subject that performs processing, but the arithmetic device 302 may be regarded as the processing subject. For the sake of convenience, the processing subject may be referred to as an audit unit.

First, the audit program 1000 receives an audit request (S1001). The audit request includes a user ID and a token ID.

The audit program 1000 searches the user information management table 1200 by the user ID and the token ID, and acquires the virtual-organization ID (S1002).

Next, the audit program 1000 acquires DeployPolicy corresponding to the token ID from the policy table 1400 (S1003).

Next, the audit program 1000 extracts, from DeployPolicy, the organization ID of the organization whose signature is essential at the time of deployment (S1004).

The audit program 1000 determines whether the virtual-organization ID acquired in S1002 matches the organization ID acquired in S1004 (S1005). If Yes, the process ends, and if No, the process proceeds to S1006. The audit program 1000 gives notice of a fraudulent policy rewriting alert (S1006).

A fraudulent policy definition is, for example, ‘Org3 AND Majority [Org1, Org2, Org3]’. This definition means that consensus building at the time of deployment of the token requires a signature of Org3 as well as signatures of a majority of the three organizations Org1, Org2, and Org3. Though a signature of Org1 is supposed to be essential since the end user has entrusted operation of the token to Org1, this policy allows the token to be deployed if approval is obtained from Org2 and Org3. This leads to execution of a transaction not desired by the end user and is thus detected as policy fraud, and then the end user is notified thereof.

As described above, in the token management system of the first embodiment, it is possible, in a consortium including a token issuing company and an investor thereof, a financial institution that mediates a transaction and an audit institution that audits a transaction result, and the like, to deploy a token with consent of an end user and verify evidence thereof. In the first embodiment, corporate bonds are taken as an example of tokens, but the present invention is not limited thereto.

In addition, in the first embodiment, description is given for the example in which the issuing company, the investor, the financial institution, the audit institution, and the like participate in the token economy. However, the participants are not limited thereto, and the content and purpose of the community are also not limited thereto.

In addition, in the first embodiment, storing information in tables is described as an example, but the information is not always stored in the tables and may be stored as schema-less data.

### Second Embodiment

In a second embodiment, a repository apparatus 110 is distributed, and a repository information table 1100 is shared as a distributed ledger 1500. In the second embodiment, a blockchain is applied to the distributed ledger 1500 and, assuming that one entry illustrated in FIG. 11 is one transaction, a plurality of transactions and a hash value constitute a block.

The other configurations are the same as those of the first embodiment.

According to the above embodiments, it is possible, in a token economy, to deploy a token with consent of an end user and verify evidence thereof so that transparency of the token economy can be improved as viewed from the end user.

Reference Signs List

| | |
|---|---|
| 100 | operation terminal |
| 110 | repository apparatus |
| 200 | end-user management apparatus |
| 300 | token processing apparatus |
| 400 | management terminal |
| 500 | token registration program |
| 600 | user management program |
| 700 | token management program |
| 800 | policy management program |
| 900 | life cycle management program |
| 1000 | audit program |
| 1100 | repository information table |
| 1200 | user information management table |
| 1300 | token information management table |
| 1400 | policy table |
| 1500 | distributed ledger |

1] A token management method for deploying a token based on a request from an end user by using an information processing system including a plurality of computers each including an arithmetic device and a memory device, the information processing system including a token registration unit, a user management unit, a token management unit, a policy management unit, and a life cycle management unit, the token management method comprising:
by the token registration unit, registering a test result, an electronic signature, and a hash of a token program in the memory device as repository information, the electronic signature and the hash being confirmation evidence;
by the user management unit, recording first consent of the end user, as a trail, to entrust operation of the token to a virtual organization, and registering the first consent in the memory device as user information management information;
by the token management unit, recording second consent of the end user, as a trail, to deploy the token, and registering the second consent in the memory device as token information management information;
by the policy management unit, updating a policy definition registered in the memory device such that a signature of the virtual organization to which the operation is entrusted is essential for deployment of the token; and
by the life cycle management unit, when a deployment request for a token is received, referring to the policy definition, and deploying the token in a case where the deployment request satisfies the policy definition.

2] The token management method according to claim 1, wherein the user information management information, the token information management information, and the policy definition are stored in the memory device as a distributed ledger and shared among the plurality of computers.

3] The token management method according to claim 1, wherein the information processing system further includes an audit unit, the token management method further comprising: by the audit unit,
referring to the user information management information and specifying a first virtual organization to which operation of the token is entrusted;
referring to the policy definition and specifying a second virtual organization of which signature is essential for deployment; and
verifying match between the first virtual organization to which operation of the token is entrusted and the second virtual organization of which signature is essential for deployment to audit the policy definition.

4] An end-user management apparatus connected via a network to a plurality of token processing apparatuses that deploy a token, the end-user management apparatus comprising a user management unit, wherein the user management unit is configured to: when receiving a user registration request from a user other than an owner of the token processing apparatuses or the end-user management apparatus, register a set of information for specifying the user and information for specifying, as an agent, an owner of at least one of the token processing apparatuses and the end-user management apparatus in a user information management table; and store the user information management table as a distributed ledger.

5] The end-user management apparatus according to claim 4, wherein the user information management table is distributed and stored in the plurality of token processing apparatuses.

6] The end-user management apparatus according to claim 5, further comprising a token management unit, wherein the token management unit is configured to: when receiving an issuance request for a first token from the user, register a set of information for specifying the user, information for specifying the first token, and information for trailing consent of the user to issue the first token in a token information management table; and distribute and store the token information management table in the plurality of token processing apparatuses.

7] The end-user management apparatus according to claim 6, wherein the token management unit is configured to:
create a policy change request to add a condition that a signature of the agent is essential for deployment of the first token;
distribute and store a policy table reflecting the policy change request in the plurality of token processing apparatuses; and
then transmit a deployment request for the first token to the token processing apparatuses.

8] The end-user management apparatus according to claim 7, wherein the token management unit is configured to: when receiving a distribution request for a second token from the user, register a set of information for specifying the user, information for specifying the second token, and information for trailing consent of the user to distribute the second token in the token information management table; and distribute and store the token information management table in the plurality of token processing apparatuses.

9] The end-user management apparatus according to claim 7, wherein at least one of the user information management table, the token information management table, and the policy table is distributed and stored in the plurality of token processing apparatuses as a distributed ledger to which a blockchain is applied.

10] A token processing apparatus that is one of the token processing apparatuses connected via the network to the end-user management apparatus according to claim 4, wherein
the token processing apparatus stores a first user information management table in which a set of information for specifying the user, information for specifying, as an agent, an owner of at least one of the token processing apparatuses and the end-user management apparatus, and information for specifying an available token is registered, and
the first user information management table constitutes a distributed ledger to which a blockchain is applied together with a second user information management table stored in another one of the token processing apparatuses.

11] The token processing apparatus according to claim 10, wherein
the token processing apparatus stores a first token information management table in which a set of information for specifying the user, information for specifying the token, and information for trailing consent of the user to issue the token is registered, and
the first token information management table constitutes a distributed ledger to which a blockchain is applied together with a second token information management table stored in another one of the token processing apparatuses.

12] The token processing apparatus according to claim 11, wherein
the token processing apparatus stores a first policy table including a deployment policy including a condition that a signature of the agent is essential for deployment of the token, and
the first policy table constitutes a distributed ledger to which a blockchain is applied together with a second policy table stored in another one of the token processing apparatuses.

13] The token processing apparatus according to claim 12, further comprising a policy management unit, wherein the policy management unit is configured to: when receiving a policy change request, acquire, based on the policy change request, information for specifying a first token related to the policy change request and information for specifying an organization that has transmitted the policy change request; refer to the first user information management table and extract an entry associated with the organization that has transmitted the policy change request for the first token related to the policy change request; and refer to the first token information management table, confirm whether a first user specified by the entry has given the consent to issue the first token related to the policy change request, and change the policy table only in a case where the consent can be confirmed.

14] The token processing apparatus according to claim 13, further comprising a life cycle management unit, wherein the life cycle management unit is configured to: when receiving a deployment request for a second token, acquire, based on the deployment request, information for specifying the second token related to the deployment request; refer to the first policy table and acquire the deployment policy for the second token related to the deployment request; and
determine, based on the deployment policy, whether deployment can be performed.

15] The token processing apparatus according to claim 14, further comprising an audit unit, wherein the audit unit is configured to: when receiving an audit request, acquire, based on the audit request, information for specifying a second user related to the audit request and information for specifying a third token related to the audit request; refer to the first user information management table and specify the agent for the second user and the third token related to the audit request;
refer to the first policy table and acquire the deployment policy for the third token related to the audit request; identify, from the deployment policy, an organization of which signature is essential at a time of deployment; and audit authenticity of the deployment policy by comparing the agent with the organization of which signature is essential.
